(19) United States
(12) Patent Application Publication
(10) Pub. No.: US 2002/0080399 A1
(43) Pub. Date: Jun. 27, 2002

(54) Data processing apparatus, data processing method, data processing program, and computer-readable memory storing codes of data processing program

(76) Inventor: Toshiyuki Nakagawa, Kanagawa (JP)

Correspondence Address: MORGAN & FINNEGAN, L.L.P., 345 PARK AVENUE, NEW YORK, NY, 10154, US

(21) Appl. No.: 09/995,913

(22) Filed: Nov. 28, 2001

(30) Foreign Application Priority Data
Nov. 30, 2000 (JP) 365837/2000

(51) Int. Cl. G06F 15/00

(52) U.S. Cl. 358/1.15

(57) ABSTRACT

Provided is a data processing apparatus/method for separating and decoding a bit stream including object data of one or plural coded moving image and audio, in units of the object data, compositing the one or plural object data thus decoded, and outputting the result of composition, which is characterized by specifying and extracting an area of first time information for synchronization management of the moving image and audio from the object data, calculating second time information for synchronization management of the moving image and audio, based on a speed conversion request from the outside and setting the second time information as the first time information, and decoding the object data, based on the second time information.

### BACKGROUND OF THE INVENTION

1. Field of the Invention

The present invention relates to a data processing apparatus, a data processing method, a data processing program for making a computer carry out the data processing, and a computer-readable memory storing codes of the data processing program, which are used, for example, in an apparatus or a system configured to separate object data of moving image and audio from a coded bit stream of MPEG (Moving Picture Experts Group)-4, decode the object data, composite the thus decoded data, and output the result.

2. Related Background Art

To date, for example, “ISO/IEC14496 part 1 (MPEG4 Systems)” standardizes techniques concerning multiplexing and synchronization of data for a coded bit stream (which will also be referred to hereinafter simply as a “bit stream”) of multimedia data including a plurality of objects of moving image, audio, and so on.

In the “MPEG4 Systems,” an ideal terminal model is called a “system decoder model” and the operation thereof is specified.

A bit stream according to the “MPEG4 Systems” (which will be referred to hereinafter as an “MPEG4 data stream”), different from the common multimedia streams heretofore, has a function of independently transmitting and receiving plural video scenes and video objects on a single stream. Accordingly, it becomes feasible to reconstitute plural video scenes and video objects from on a single stream. This also applies similarly to audio, and it is feasible to reconstitute plural audio objects from on a single stream.

Further, in addition to the conventional video objects and audio objects, the MPEG4 data stream also includes BIFS (Binary Format for Scene) to extend VRML (Virtual Reality Modeling Language) so as to be able to deal with natural moving image and audio as information for defining spatial and temporal arrangement of objects. This BIFS is binary coded information of a scene (an arbitrary scene composed of video objects and audio objects) in MPEG-4.

Therefore, since individual objects necessary for reproduction of a scene (composition of objects) are optimally coded separately from each other and then sent, the receiver side (reproduction side) decodes each of the coded data of the individual objects, establishes synchronization to match a time axis of the individual objects with its own time axis on the receiver side, based on the contents of the foregoing BIFS, and composites the individual objects to reproduce the scene.

Incidentally, variable speed reproduction is required in the case of receiving and reproducing the data stream including a plurality of object data as described above.

For the variable speed reproduction, for example, it is necessary to provide a function of reproducing a scene at a higher speed than a normal reproduction speed (fast reproduction function), which is needed on the occasion of fast-forwarding reproduction for permitting a user to watch a moving picture in a short time, and a function of reproducing a scene at a lower speed than the normal reproduction speed (slow reproduction function), which is needed when the user carefully watches a moving picture.

For this purpose, some techniques of speed conversion of only audio have been proposed heretofore, and as a technique for making the speed of moving picture (video image) variable in synchronism (lip-synchronization or lip-sync) with speed conversion of audio, there is a proposed technique of interpolating video fields in synchronism with audio of converted reproduction speed, using an audio decoder based on a speed conversion algorithm and a moving image decoder based on a conversion algorithm of carrying out the field interpolation according to a motion vector.

According to the above technique conventionally proposed as a technique for making the speed of video image variable in synchronism with the speed conversion of audio, however, it was infeasible to make the speed of video image variable in synchronism with the speed conversion of audio unless the conversion algorithm of carrying out the field interpolation according to the motion vector was mounted on the moving image decoder. Namely, it was indispensable to mount the conversion algorithm of carrying out the field interpolation according to the motion vector, on the moving image decoder, and a moving image decoder without such a special algorithm was unable to make the speed of video image variable in synchronism with the speed conversion of audio.

### SUMMARY OF THE INVENTION

Under the circumstances as described above, an object of the present invention is to provide a data processing apparatus, a data processing method, a data processing program, and a computer-readable memory storing codes of the data processing program, which permit the video image to be made simultaneously variable in synchronism (lip-sync) with the speed conversion of audio in a simple configuration even in the case of a moving image decoder without the special algorithm of the field interpolation or the like as described above.

For accomplishing the above object, a data processing apparatus in a preferred embodiment of the invention is a data processing apparatus for decoding and reproducing object data separated from a coded bit stream including at least object data of moving image and audio, based on first time information for synchronization management of the moving image and audio included in the object data, the data processing apparatus of the present invention comprising: time information acquiring means for acquiring second time information for synchronization management of the moving image and audio, based on a speed conversion request from the outside; setting means for setting the second time information acquired by the time information acquiring means, as the first time information; and decoding means for decoding the object data, based on the second time information.

A data processing method in another preferred embodiment of the invention is a data processing method for separating and decoding a bit stream including object data of one or plural coded moving image and audio, in units of the object data, compositing the one or plural object data thus decoded, and outputting the result of composition, the data processing method of the present invention comprising: an extraction step of specifying and extracting an area of first time information for synchronization management of the moving image and audio from the object data; a setting step of calculating second time information for synchronization management of the moving image and audio, based on a speed conversion request from the outside, and setting the second time information as the first time information; and a decoding step of decoding the object data, based on the second time information.

A data processing program in another preferred embodiment of the invention is a data processing program, which can be executed by a computer, for separating and decoding a bit stream including object data of one or plural coded moving image and audio, in units of the object data, compositing the one or plural object data thus decoded, and outputting the result of composition, the data processing program of the present invention comprising: a code of an extraction step of specifying and extracting an area of first time information for synchronization management of the moving image and audio from the object data; a code of a setting step of calculating second time information for synchronization management of the moving image and audio, based on a speed conversion request from the outside, and setting the second time information as the first time information; and a code of a decoding step of decoding the object data, based on the second time information.

A computer-readable memory in another preferred embodiment of the invention is a computer-readable memory storing a data processing program for separating and decoding a bit stream including object data of one or plural coded moving image and audio, in units of the object data, compositing the one or plural object data thus decoded, and outputting the result of composition, the data processing program comprising: a code of an extraction step of specifying and extracting an area of first time information for synchronization management of the moving image and audio from the object data; a code of a setting step of calculating second time information for synchronization management of the moving image and audio, based on a speed conversion request from the outside, and setting the second time information as the first time information; and a code of a decoding step of decoding the object data, based on the second time information.

Other objects, features and advantages of the invention will become apparent from the following detailed description taken in conjunction with the accompanying drawings.

### BRIEF DESCRIPTION OF THE DRAWINGS

FIG. 1 is a block diagram showing a configuration of a data processing apparatus to which the present invention is applied;

FIG. 2 is a diagram for explaining a synchronization model and buffer management in the data processing apparatus of FIG. 1;

FIG. 3 is a flowchart for explaining the operation of a speed conversion unit in the data processing apparatus of FIG. 1;

FIG. 4 is a diagram for explaining a synchronization model and buffer management in the case where the speed conversion reproduction is carried out by the speed conversion unit 116 of FIG. 1; and

FIG. 5 is a block diagram showing a configuration of a computer function that makes it feasible to execute processing equivalent to that of the data processing apparatus of FIG. 1.

### DETAILED DESCRIPTION OF THE PREFERRED EMBODIMENTS

Embodiments of the present invention will be described below with reference to the drawings.

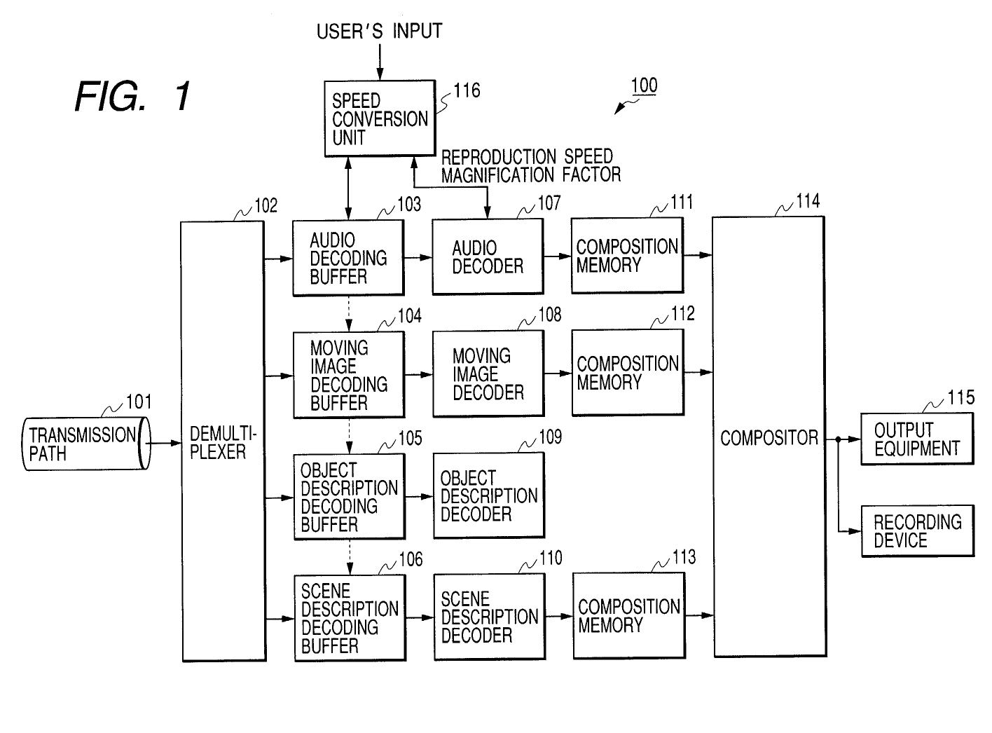

The present invention is applied, for example, to a data processing apparatus 100 as shown in FIG. 1.

The data processing apparatus 100 of the present embodiment has the reproduction function (MPEG-4 reproduction function) of separating object data from a bit stream (MPEG-4 data stream) including object data of moving images and audio etc. coded in MPEG-4, decoding the object data, compositing the thus decoded object data, and outputting the result of composition, and, particularly, is configured to reproduce a scene while also establishing synchronization between moving image and audio on the occasion of conversion of reproduction speed.

Overall structure and sequential operation of data processing apparatus 100

As shown in FIG. 1, the data processing apparatus 100 has a demultiplexer 102 which receives the MPEG-4 data stream from a transmission path 101 of a network or the like and separates data of various objects and others; an audio decoding buffer 103 and an audio decoder 107 which decode audio object data obtained in the demultiplexer 102; a moving image decoding buffer 104 and a moving image decoder 108 which decode moving image object data obtained in the demultiplexer 102; an object description decoding buffer 105 and an object description decoder 109 which decode object description data obtained in the demultiplexer 102; and a scene description decoding buffer 106 and a scene description decoder 110 which decode scene description data obtained in the demultiplexer 102.

The apparatus further includes a compositor 114 which reconstructs a scene from output of the audio decoder 107 acquired via composition memory 111, output of the moving image decoder 108 acquired via composition memory 112, output of the object description decoder 109, and output of the scene description decoder 110 acquired via composition memory 113, and is configured to supply output of the compositor 114 to output equipment 115 of a display, loudspeakers, etc., or to a recording device 116 having a hard disk or the like.

Particularly, the data processing apparatus 100 is configured to specify and extract an area of first time information for synchronization management (DTS (Decoding Time Stamp): time information specifying a time until which an AU (Access Unit) has to arrive at the decoding buffer, CTS (Composition Time Stamp): time information specifying a time until which a CU (Composition Unit (specifically, equivalent to VOP (Video Object Plane) in MPEG-4 visual)) has to exist in the composition memory) from the object data (AU (Access Unit): a unit which is obtained by division of ES (Elementary Stream), which is a processing unit for time management and synchronization for decoding and composition, and which is equivalent, for example, to coded data of VOP (Video Object Plane) in MPEG-4 visual) obtained from the MPEG-4 data stream, calculate second time information (DTS, CTS) according to a speed conversion request from the user, set the result (second time information) as first time information (DTS, CTS) of the object data (AU), and notify the audio decoder 107 for decoding the audio object data, of a reproduction speed magnification factor according to the user's speed conversion request.

In the data processing apparatus 100 as described above, first, the transmission path 101 is a transmission line typified by various networks or the like, and the present embodiment employs as an example thereof a network for transmitting the MPEG-4 data stream (MPEG-4 bit stream). For this reason, the transmission path will be called hereinafter “network 101”.

It is noted herein that the transmission path 101 in the present embodiment does not refer to only a communication line such as a broadcasting network, a communication network, or the like, but also embraces a storage medium (recording medium) itself such as DVD-RAM or the like, for example.

When receiving the MPEG-4 bit stream transmitted through the network 101 (or the MPEG-4 bit stream read out of a recording medium when the transmission path 101 represents the recording medium), the data processing apparatus 100 feeds it to the demultiplexer 102.

The demultiplexer 102 separates the audio object data, the moving image object data, the object description data, the scene description data, and so on from the thus fed MPEG-4 bit stream and then supplies each data to the associated decoding buffer among the decoding buffers 103 to 106. Units of input data into the decoding buffers 103 to 106 are AU units.

The audio object data is high-efficiency (compression) coded data by a coding method having the reproduction speed conversion function, like the parametric coding (HVXC: Harmonic Vector Excitation Coding) or the like as a coding method for audio of low-bit rate.

The moving image object data is high-efficiency coded data, for example, by the known MPEG-2 or H-263 system.

The object description data includes control information of each media object (information about the coding method, a relation with scene description, a configuration of a packet, or the like), and each bit stream data of media object is decoded by a decoding algorithm (MPEG-4 visual, MPEG-4 audio, IPMP (Intellectual Property Management and Protection), MPEG-7, etc.) based on the information of the coding method included in the object description data.

Each of the decoding buffers 103 to 106, receiving an AU as described above, outputs the AU to the associated decoder among the decoders 107 to 110.

The decoders 107 to 110 decode the input AU and outputs decoded data.

Namely, the audio decoder 107 decodes the input AU and outputs the result as a CU to the composition memory 111.

The moving image decoder 108 also decodes the input AU and outputs the result as a CU to the composition memory 112.

The scene description decoder 110 also decodes the input AU and outputs the result as a CU to the composition memory 113.

In the present embodiment, since the apparatus is configured to be able to perform decoding even if there exist a plurality of objects of mutually different kinds, i.e., the audio object data, moving image object data, and object description data in the MPEG-4 bit stream, the decoding buffers and decoders are provided in one-to-one correspondence for each object data.

The compositor 114 composites the output (audio object) of the composition memory 111 and the output (moving image object) of the composition memory 112, based on the output (object description data) of the object description decoder 109 and the output (scene description data) of the composition memory 113, thereby reproducing (or reconstructing) a scene.

The data of the scene thus reproduced (a final multimedia data string) is fed to the output equipment 115 of the display, loudspeakers, etc. and the scene consisting of the moving image and audio is reproduced in the output equipment 115.

Configuration and operation characteristic of data processing apparatus 100

First, when an AU as described above is packeted, time information (DTS, CTS, etc.) for synchronization management is added to a packet header part thereof.

DTS (Decoding Time Stamp) is time information specifying a time until which an AU has to arrive at the decoding buffer, and CTS (Composition Time Stamp) is time information specifying a time until which a CU has to exist in the composition memory.

Accordingly, the AU is decoded at the time represented by DTS added to the packet header part provided for every packet, and is instantaneously converted to a CU, which becomes effective at a time after the time indicated by the CTS.

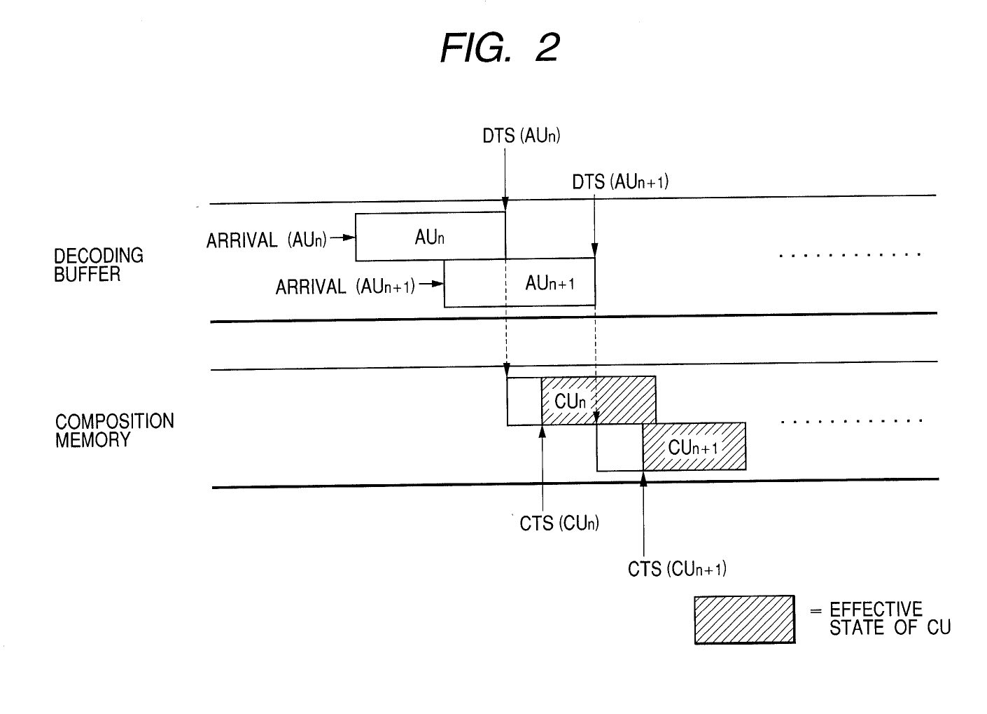

FIG. 2 specifically shows the relation of the time information (DTS, CTS) with the decoding buffer and composition memory.

First, an arbitrary AUₙ fed into the decoding buffer is decoded before a time DTS(AUₙ) added to the packet header part, to be converted into a CUₙ, which is outputted to the composition memory.

Then the CUₙ becomes effective at a time CTS(CUₙ) added to the packet header part, to turn into a state capable of undergoing composition and reproduction in the compositor 114.

Subsequently, a next AUₙ₊₁ fed into the decoding buffer is also decoded before a time DTS(AUₙ₊₁) to be converted into a CUₙ₊₁, which is outputted to the composition memory.

Then the CUₙ₊₁ becomes effective at a time CTS(CUₙ₊₁) to turn into a state capable of undergoing composition and reproduction in the compositor 114.

The most characteristic configuration of the present embodiment is a speed conversion unit 116. This speed conversion unit 116 is an operation unit for converting a reproduction speed according to an instruction from the user.

When the data processing apparatus 100 of the present embodiment receives a reproduction speed change command from the user, the speed conversion unit 116 receives this command.

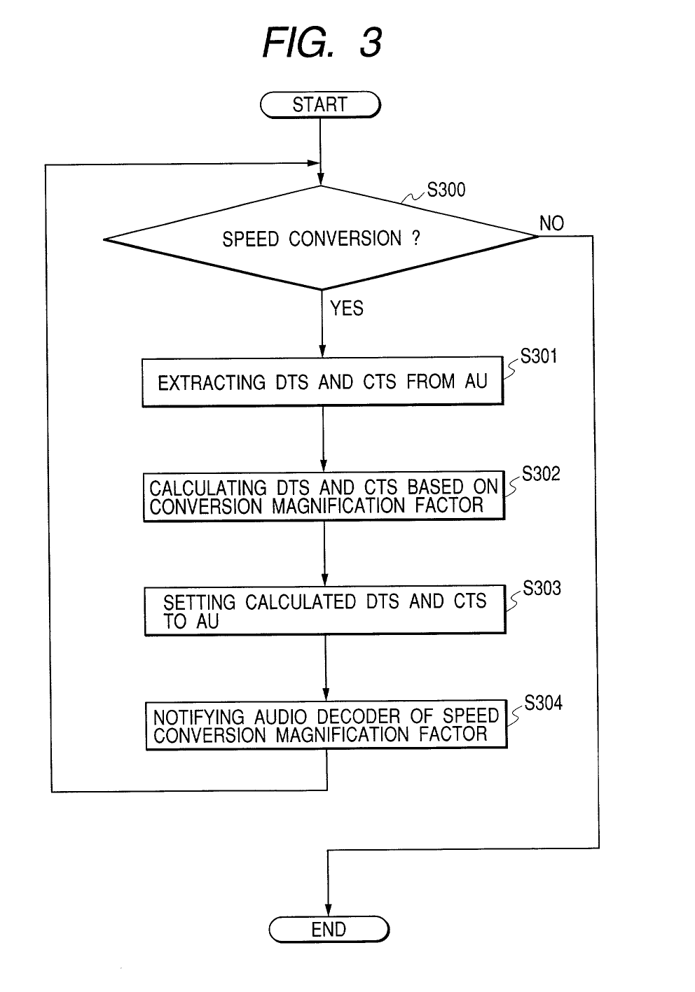

FIG. 3 shows a flowchart of the operation of the speed conversion unit 116 carried out when the data processing apparatus 100 receives the MPEG-4 bit stream.

First, the speed conversion unit 116 determines whether the user requests reproduction speed conversion (step S300).

When the determination at step S300 results in no request for the reproduction speed conversion, this processing is terminated. When there is a request for the reproduction speed conversion, processing at next step S301 and thereafter is carried out.

When the result of the determination at step S300 is that the user requests the reproduction speed conversion, the speed conversion unit 116 extracts DTS and CTS (first time information) added to the packet header part of each AU fed into each of the decoding buffers 103 to 106 (step S301).

In order to change the DTS and CTS (first time information) extracted at step S301, the speed conversion unit 116 next calculates DTS′ and CTS′ (second time information), based on a time t when the user requested the reproduction speed conversion and on a reproduction speed conversion magnification factor i designated by the user (step S302).

Then the speed conversion unit 116 sets the DTS′ and CTS′ (second time information) acquired at step S302, as new DTS and CTS (first time information) extracted at step S301 (step S303).

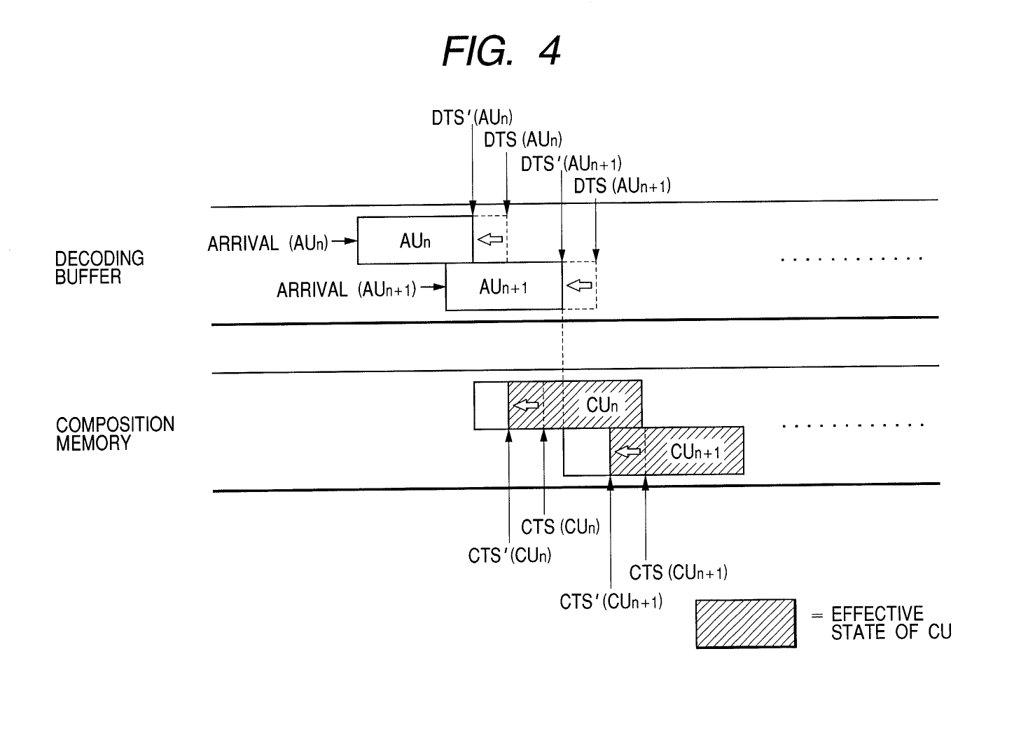

FIG. 4 specifically shows the processing at step S303.

First, times DTS(AUₙ) and CTS(CUₙ) (first time information) added to the packet header part are extracted from an arbitrary AUₙ fed into the decoding buffer.

Then, using the time t when the user requested the reproduction speed conversion (the request for change of the reproduction speed magnification factor i and reproduction speed), the following calculations are carried out.

DTS′(AUₙ)=t+{DTS(AUₙ)−t}/i

={(i−1)t+DTS(AUₙ)}/i

CTS′(CUₙ)=t+{CTS(CUₙ)−t}/i

={(i−1)t+CTS(CUₙ)}/i

Then the speed conversion unit sets the DTS′(AUₙ) and CTS′(CUₙ) (second time information) thus calculated, as new DTS and CTS of AUₙ.

Accordingly, the AUₙ is decoded to be converted into the CUₙ in the decoder before the time DTS′(AUₙ), and the CUₙ is outputted to the composition memory.

The CUₙ becomes effective at the time CTS′(CUₙ) to turn into the state capable of undergoing composition and reproduction in the compositor 114.

The foregoing “time t ” is a time that has elapsed from a time of a start of reproduction of the moving image object data and audio object data in the MPEG-4 bit stream fed into the data processing apparatus 100, to the time when the user requested the change of speed. The “time t” can be determined, for example, by applying a time read from a clock inside a computer (not shown) or from a clock inside the data processing apparatus 100, or by applying an actual utilization time calculated from the time thus read.

In FIG. 4, the reproduction speed magnification factor i is assumed to be a value not less than “1” as an example, in which DTS′(AUₙ) is smaller than DTS(AUₙ) while CTS′(CUₙ) is smaller than CTS(CUₙ).

Namely, since the time to turn into the effective state becomes earlier for an arbitrary CUₙ, the reproduction becomes faster than the normal reproduction.

When a value not more than “1” is used as the reproduction speed magnification factor i on the other hand, DTS′(AUₙ) becomes greater than DTS(AUₙ), while CTS′(CUₙ) is greater than CTS(CUₙ). The time when the CUₙ turns into the effective state, becomes later, and thus the reproduction becomes slower than the normal reproduction.

After the processing at step S303 as described above, the speed conversion unit 116 notifies the audio decoder 107 of the reproduction speed magnification factor i (step S304).

After that, the speed conversion unit 116 returns to step S300 in order to execute the processing for the next AU fed into the decoding buffer.

Accordingly, when the audio decoder 107 receives the reproduction speed magnification factor i from the speed conversion unit 116, it decodes the AU in the audio decoding buffer 103 so as to convert the reproduction speed according to the reproduction speed magnification factor i.

The reproduction speed conversion function in the present embodiment, as described above, is a function making use of such a feature of the parametric coding that decoding can be implemented even if values and settings of parameters are arbitrarily changed upon decoding, because the coded data (MPEG-4 bit stream) is completely parameterized. It realizes the reproduction speed conversion by changing renewal periods of coded parameters (time information).

Therefore, the reproduction function (MPEG-4 reproduction function) and the control method of the data processing apparatus 100 in the present embodiment are able to simultaneously reproduce the moving image at variable speeds in synchronism (lip-sync) with the speed conversion of audio, even in use of the conventional moving image decoder without the special algorithm of the field interpolation or the like, on the occasion of separating and reproducing the respective object data from the bit stream (MPEG-4 bit stream) including one or plural coded moving image object data and audio object data.

In the present embodiment, the time information (time stamps) such as the DTS and CTS is option information of the packet header, and this information might not be necessary in certain cases.

It is needless to mention that, for example, where there exists other synchronization information, the function in the present embodiment can be carried out, using the foregoing other synchronization information instead of DTS and CTS.

It is also needless to mention that the object of the present invention can also be accomplished by a configuration wherein a memory storing program codes of software for implementing the functions of the host and terminal in the present embodiment is supplied to a system or a device and wherein a computer (or a CPU or an MPU) in the system or the device reads the program codes stored in the memory and executes them.

In this case, the program codes themselves read out of the memory realize the function of the present embodiment, and thus the memory storing the program codes constitutes the present invention.

The memory for supplying the program codes can be either of a ROM, a floppy disk, a hard disk, an optical disk, a magnetooptical disk, a CD-ROM, a CD-R, a magnetic tape, a nonvolatile memory card, and so on.

It is also needless to mention that the present invention does not embrace only the configuration in which the function of the present embodiment is implemented by carrying out the program codes read by the computer, but also embraces a configuration in which an OS or the like operating on the computer carries out part or all of actual processing, based on instructions of the program codes, and in which the function of the present embodiment is implemented by the processing.

Further, it is a matter of course that the invention also embraces a configuration wherein the program codes read out of the memory are written into a memory provided in an extension board inserted into the computer or in an extension unit connected to the computer, thereafter a CPU provided in the extension board or the extension unit carries out part or all of the actual processing, based on instructions of the program codes, and the function of the present embodiment is implemented by the processing.

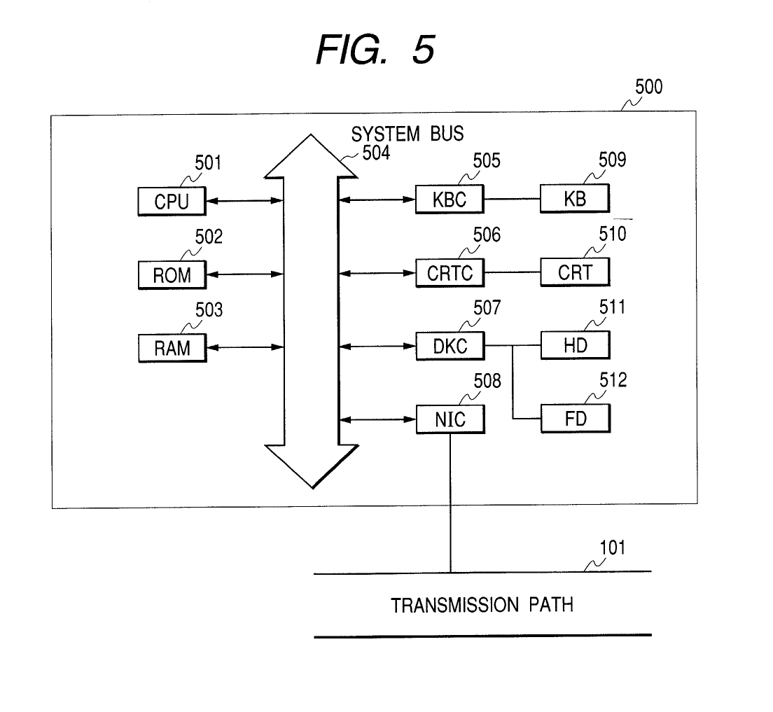

For example, the data processing apparatus 100 of FIG. 1 has a computer function 500 as shown in FIG. 5.

CPU 501 of this computer 500 carries out the operation in the present embodiment as described above.

The computer function 500 has such a configuration, as shown in FIG. 5, that CPU 501, ROM 502, RAM 503, keyboard controller (KBC) 505 for keyboard (KB) 509, CRT controller (CRTC) 506 for CRT display (CRT) 510 as a display unit, disk controller (DKC) 507 for hard disk (HD) 511 and floppy disk (FD) 512, and network interface card (NIC) 508 are connected in a communicable state with each other through system bus 504.

Then the system bus 504 is connected to the transmission path (network or the like) 101 shown in FIG. 1.

The CPU 501 systematically controls each constitutive part connected to the system bus 504 by carrying out software stored in the ROM 502 or in the HD 511 or software supplied from the FD 512.

Namely, the CPU 501 reads the processing program according to the processing sequence as shown in FIG. 3, out of the ROM 502, HD 511, or FD 512 and carries out it, thereby performing the control for implementing the aforementioned operation in the present embodiment.

The RAM 503 functions as a main memory, a work area, or the like of the CPU 501.

The KBC 505 controls input of instructions from the KB 509, a pointing device not shown, and so on.

The CRTC 506 controls display of the CRT 510.

The DKC 507 controls access to the HD 511 and FD 512 which store a boot program, various applications, edit files, user files, a network management program, the foregoing processing program in the present embodiment, and so on.

The NIC 508 exchanges data in two ways with a device or system or the like on the transmission path 101.

In the present embodiment, as described above, since the apparatus is configured to newly set the second time information acquired based on the speed conversion request from the outside (the user or the like), as the first time information (information for synchronization management) used on the occasion of decoding and reproducing the object data of moving image and audio, and notify the decoding means for audio object data (audio decoder) of the reproduction speed magnification factor indicated by the speed conversion request from the outside (the user or the like), the moving image can be simultaneously reproduced at variable speeds in synchronism (lip-sync) with the speed conversion of audio, even in use of the conventional decoding means (decoder) for moving image without the special algorithm of the field interpolation or the like, and thus a flexible and expansive data processing apparatus or system can be realized readily.

In other words, the foregoing description of embodiments has been given for illustrative purposes only and not to be construed as imposing any limitation in every respect.

The scope of the invention is, therefore, to be determined solely by the following claims and not limited by the text of the specifications and alterations made within a scope equivalent to the scope of the claims fall within the true spirit and scope of the invention.

What is claimed is:

1. A data processing apparatus for decoding and reproducing object data separated from a coded bit stream including at least object data of moving image and audio, based on first time information for synchronization management of the moving image and audio included in the object data, said data processing apparatus comprising:
a) time information acquiring means for acquiring second time information for synchronization management of the moving image and audio, based on a speed conversion request from the outside;
b) setting means for setting the second time information acquired by the time information acquiring means, as the first time information; and
c) decoding means for decoding the object data, using said second time information.

2. An apparatus according to claim 1, wherein the coded bit stream includes a bit stream based on MPEG-4.

3. An apparatus according to claim 1, wherein the object data of audio includes data coded by high-efficiency compression coding according to a coding method having a reproduction speed conversion function.

4. An apparatus according to claim 1, further comprising extracting means for extracting the first time information from an access unit of the object data fed into a buffer for decoding target data.

5. An apparatus according to claim 1, wherein the decoding means of the object data of audio has a reproduction speed conversion function.

6. An apparatus according to claim 1, wherein the time information includes a DTS (Decoding Time Stamp) and a CTS (Composition Time Stamp).

7. An apparatus according to claim 1, further comprising notifying means for notifying the decoding means for the object data of audio, of a reproduction speed magnification factor indicated by said speed conversion request.

8. A data processing method for separating and decoding a bit stream including object data of one or plural coded moving image and audio, in units of the object data, compositing the one or plural object data thus decoded, and outputting the result of composition, said data processing method comprising:
a) an extraction step of specifying and extracting an area of first time information for synchronization management of the moving image and audio from the object data;
b) a setting step of calculating second time information for synchronization management of the moving image and audio, based on a speed conversion request from the outside, and setting the second time information as the first time information; and
c) a decoding step of decoding the object data, based on the second time information.

9. A method according to claim 8, wherein the bit stream includes a bit stream of MPEG-4.

10. A method according to claim 8, wherein the object data of audio includes data coded by high-efficiency compression coding according to a coding method having a reproduction speed conversion function.

11. A method according to claim 8, wherein said extraction step includes a step of extracting said first time information from an access unit fed into a decoding buffer for the object data.

12. A method according to claim 8, wherein said decoding step includes a reproduction speed conversion function.

13. A method according to claim 8, wherein the time information includes a DTS (Decoding Time Stamp) and a CTS (Composition Time Stamp).

14. A method according to claim 8, further comprising a notification step of notifying an audio decoder for decoding the object data of audio, of a reproduction speed magnification factor according to the speed conversion request.

15. A data processing program, which can be executed by a computer, for separating and decoding a bit stream including object data of one or plural coded moving image and audio, in units of the object data, compositing the one or plural object data thus decoded, and outputting the result of composition, said data processing program comprising:
a) a code of an extraction step of specifying and extracting an area of first time information for synchronization management of the moving image and audio from the object data;
b) a code of a setting step of calculating second time information for synchronization management of the moving image and audio, based on a speed conversion request from the outside, and setting the second time information as the first time information; and
c) a code of a decoding step of decoding the object data, based on the second time information.

16. A computer-readable memory storing a data processing program for separating and decoding a bit stream including object data of one or plural coded moving image and audio, in units of the object data, compositing the one or plural object data thus decoded, and outputting the result of composition, said data processing program comprising:
a) a code of an extraction step of specifying and extracting an area of first time information for synchronization management of the moving image and audio from the object data;
b) a code of a setting step of calculating second time information for synchronization management of the moving image and audio, based on a speed conversion request from the outside, and setting the second time information as the first time information; and
c) a code of a decoding step of decoding the object data, based on the second time information.
